(19) United States
(12) Patent Application Publication
(10) Pub. No.: US 2022/0017361 A1
(43) Pub. Date: Jan. 20, 2022

(54) CENTER-BALANCE HINGED STIRRUP BAR

(71) Applicant: SCHLEESE SADDLERY SERVICE LTD., Holland Landing (CA)

(72) Inventor: Joachim Schleese, Newmarket (CA)

(21) Appl. No.: 16/932,770

(22) Filed: Jul. 19, 2020

(51) Int. Cl. B68C 1/16

(52) U.S. Cl. CPC B68C 1/16

(57) ABSTRACT

A center-balance hinged stirrup bar is comprised of at least one interchangeable hooked and elongated portion that may move radially about a stirrup bar joint. The elongated portion of the hinged stirrup bar may be attached to the middle portion of a saddle tree of a saddle, with the hooked portion positioned at a front portion of the saddle where it receives stirrup leathers to create a pivot point for stirrups. This configuration helps equalize the distribution of a rider's weight across the back of a horse and reduces the risk posed by abnormal pressure points to horse welfare and riding performance. Such a configuration is especially suitable for use in saddle types and riding styles where a two-point riding position is common.

### FIELD OF THE INVENTION

The present specification relates generally to stirrup bars and more specifically to a hinged stirrup bar comprised of a hooked portion and an elongated portion that connect to create an adjustable joint and which attaches to a middle portion of a saddle to create a pivot point for stirrup leather at a front portion of the saddle.

### BACKGROUND OF THE INVENTION

The purpose of a stirrup bar in horse riding is to hold stirrup leathers on a saddle, with the stirrup leathers ending in the stirrups themselves. Stirrups receive a rider's feet and, thus, are generally paired. Stirrups, in conjunction with stirrup leathers and the stirrup bar, help a rider mount a horse and improve a rider's ability to remain in the saddle and more effectively control the weight and momentum of horse and rider. This increase in stability and control has a direct impact on a rider's comfort and performance in work and sport.

Stirrup bars found in the prior art are attached at the front of a saddle near the pommel to allow a rider to balance oneself while riding. Stirrup bars are directly secured onto the sides of a gullet plate, which lies over the wither area on the left and right dorsal side of a horse, and at the top of the spring steel, which runs front-to-back down the length of a horse's back under the saddle. Some stirrup bars are attached only at the spring steel's top portion at the front of a saddle, whereas others are also attached onto the spring steel at the back of the saddle.

Consequently, every time a rider puts their weight into the stirrups their weight is pushed onto either the front of the saddle or a combination of the front and back of the saddle. This creates an uneven distribution of the rider's weight across the dorsal portion of a horse's back that is in contact with a saddle.

Improper weight distribution can cause abnormal pressure points and significant health problems over a riding season, including lameness, behavioral changes, muscle tension, pain, and permanent damage to the withers or spinal processes. These detrimental effects can compound over the lifetime of a horse, leading to a progressive decline in a horse's performance and welfare.

Accordingly, there is a need for improvements in the art.

### SUMMARY OF THE INVENTION

In an embodiment of the present invention, there is provided a hinged stirrup bar comprising a hooked portion for receiving stirrup leather and an elongated portion, wherein the hooked portion and the elongated portion each contain at least one protruding element which interlock to connect the hooked portion and the elongated portion at an adjustable stirrup bar joint, and wherein the adjustable stirrup bar joint is secured using at least one fastener.

According to an embodiment, the adjustable stirrup bar joint can be secured by threading a pin-based fastener through apertures on the protruding elements of the hooked and elongated portions. The hinge permits free radial movement of the hooked portion and elongated portion. The hooked portion may have an aperture for receiving stirrup leathers to help secure stirrup leathers to the stirrup bar. The hooked or elongated portions may also be interchanged with other hooked or elongated portions of different dimensions and designs. The dimensions and designs of the hooked or elongated portions may be configured for use in English and Western saddles.

In an embodiment of the present invention, the hinged stirrup bar may be installed on a saddle, comprising a saddle tree; at least one saddle tree covering; a gullet plate; stirrup leather; at least one stirrup; wherein the saddle is comprised of a front portion, a middle portion, and a rear portion; wherein the saddle tree is comprised of a front tree portion, a middle tree portion, and a rear tree portion; wherein the hinged stirrup bar is installed at the middle portion of the saddle by attaching it to the middle tree portion of the saddle tree using at least one installation fastener; and wherein the hinged stirrup bar creates a pivot point for the stirrup leather at the front portion of the saddle.

According to an embodiment, the hinged stirrup bar may reduce saddle rocking, impedance to horse movement, or front or rear pressure from the saddle. The hinged stirrup bar may distribute a rider's weight more evenly across the saddle and the front, middle, and rear portions of the saddle may be designed to also distribute weight more equally across the saddle. The hinged stirrup bar may be a pair with non-superimposable, mirrored designs. The hinged stirrup bar may be used in conjunction with other saddle design choices to improve comfort, performance, or safety. The designs and dimensions of the saddle and its comprising elements may make the invention especially suitable for use in English and Western saddles or in saddle types and riding styles where a two-point riding position is common.

In an embodiment of the present invention, there is a method of balancing a rider's weight on a horse by attaching a hinged stirrup bar as described above to the middle of a saddle that creates a pivot point at the front of the saddle and positioning the saddle over the saddle support area of the horse to create an approximately equal weight distribution.

Other aspects and features according to the present application will become apparent to those ordinarily skilled in the art upon review of the following description of embodiments of the invention in conjunction with the accompanying figures.

### BRIEF DESCRIPTION OF THE FIGURES

The principles of the invention may better be understood with reference to the accompanying figures provided by way of illustration of an exemplary embodiment, or embodiments, incorporating principles and aspects of the present invention, and in which:

FIG. 1 shows how the part of a horse's back where a saddle sits can be divided into a front, middle, and rear section of approximately equal surface area;

FIGS. 2(a) to 2(i) show a center-balance hinged stirrup bar in assembled and disassembled conformations, according to an embodiment;

FIG. 3 shows a pair of center-balance hinged stirrup bars with a pin-based fastener and which have non-superimposable, mirrored designs, according to an embodiment; and

FIGS. 4(a) and 4(b) show how a pair of center-balance hinged stirrup bars may be installed on a saddle tree, according to an embodiment.

### DETAILED DESCRIPTION OF EMBODIMENTS OF THE INVENTION

The description that follows, and the embodiments described therein, are provided by way of illustration of an example, or examples, of particular embodiments of the principles of the present invention. These examples are provided for the purposes of explanation, and not of limitation, of those principles and of the invention. In the description, like parts are marked throughout the specification and the drawings with the same respective reference numerals. The drawings are not necessarily to scale and in some instances proportions may have been exaggerated in order to more clearly to depict certain features of the invention.

According to an embodiment, this description relates to a hinged stirrup bar comprising a hooked portion for receiving stirrup leather, an elongated portion, wherein the hooked portion and the elongated portion each contain at least one protruding element which interlock to connect the hooked portion and the elongated portion at an adjustable stirrup bar joint, and wherein the adjustable stirrup bar joint is secured using at least one fastener.

According to further embodiments, this description relates to how the at least one fastener may be a pin fitted through apertures on the at least one protruding element on each of the hooked portion and the elongated portion and which may have welded ends to help secure the pin in place once fitted through the apertures. There may be three protruding elements on the hooked portion and two protruding elements on the elongated portion. The adjustable stirrup bar joint may permit radial movement of the hooked portion and the elongated portion such that position of the hooked portion and the elongated portion may conform to a horse's body shape. The hooked portion may have at least one stirrup leather aperture for receiving stirrup leather. The hooked portion or the elongated portion may be interchangeable with different hooked portions or elongated portions. The dimensions and designs of the hooked portion and the elongated portion may be configured for use in English or Western saddles.

According to an embodiment, this description relates to a saddle, comprising a saddle tree; at least one saddle tree covering; a gullet plate; stirrup leather; at least one stirrup; at least one hinged stirrup bar comprising a hooked portion for receiving stirrup leather, an elongated portion, wherein the hooked portion and the elongated portion each contain at least one protruding element which interlock to connect the hooked portion and the elongated portion at an adjustable stirrup bar joint, and wherein the adjustable stirrup bar joint is secured using at least one fastener; wherein the saddle is comprised of a front portion, a middle portion, and a rear portion; wherein the saddle tree is comprised of a front tree portion, a middle tree portion, and a rear tree portion; wherein the hinged stirrup bar is installed at the middle portion of the saddle by attaching it to the middle tree portion of the saddle tree using at least one installation fastener; and wherein the hinged stirrup bar creates a pivot point for the stirrup leather at the front portion of the saddle.

According to further embodiments, this description relates to how the pivot point may reduce rocking of the saddle, impedance to a horse's movement, or pressure at the front portion or rear portion of the saddle. The pivot point may distribute a rider's weight more evenly across the front portion, the middle portion, and the rear portion of the saddle. The at least one hinged stirrup bar may be a pair of hinged stirrup bars with non-superimposable, mirrored designs. The at least one hinged stirrup bar may be used in conjunction with other saddle design choices, like the saddle tree's length or the saddle's curvature, to improve comfort, performance, or safety. The at least one installation fastener may be a set of three rivets securing the elongated portion to the middle tree portion. The front portion, the middle portion, and the rear portion of the saddle may be designed such that a weight applied to the middle portion is distributed more evenly across the front portion, the middle portion, and the rear portion of the saddle. Dimensions and designs of the saddle tree, the at least one saddle tree covering, the gullet plate, the stirrup leather, the at least one stirrup, the hooked portion, and the elongated portion may be configured for use in English and Western saddles and generally for any saddle type where a two point riding position is used.

According to an embodiment, this description relates to a method of balancing a rider's weight on a horse, comprising installing a hinged stirrup bar on a middle portion of a saddle; placing the saddle on a saddle support area on the horse's back; positioning the saddle over the saddle support area such that a front portion, the middle portion, and a rear portion of the saddle align with a front support portion, a middle support portion, and a rear support portion of the saddle support area; securing the saddle to the horse using at least one saddle fastener; and applying the rider's weight approximately evenly across the saddle support area using a pivot point for stirrup leather created at the front portion of the saddle by the hinged stirrup bar on the middle portion of the saddle.

According to further embodiments, the approximately even application of the rider's weight may reduce rocking of the saddle, impedance to the horse's movement, or pressure at the front portion or rear portion of the saddle. The saddle support area may be approximately 4 inches wide by 16 inches long on each side of a horse's back. A saddle tree of the saddle may be adjusted to conform to a horse's body shape by bending a gullet plate that can be installed on the saddle tree. The gullet plate may be bent by hydraulics, manually, or by other means without impacting the structure of the saddle tree or without bending, distorting, or breaking the hinged stirrup bar.

### The Importance of Equal Weight Distribution on Horse Welfare and Performance

The saddle tree acts as the foundation of a saddle in distributing a rider's weight over the back of a horse. A saddle ought to be fitted onto the saddle support area of a horse's back, which measures approximately 4 inches wide and 16 inches long on each side of the horse's spinal column. The distribution of a rider's weight in the saddle support area ought to achieve the most even pressure distribution possible across the dorsal surface area of the horse to maximize comfort and riding performance. However, many stirrup bars in the prior art fail to optimally distribute a rider's weight and, instead, create harmful pressure points when the stirrups are used. These localized, high pressure areas are not only painful for a horse but may also increase capillary pressure to such an extent that there is a risk of ischemic or other internal damage.

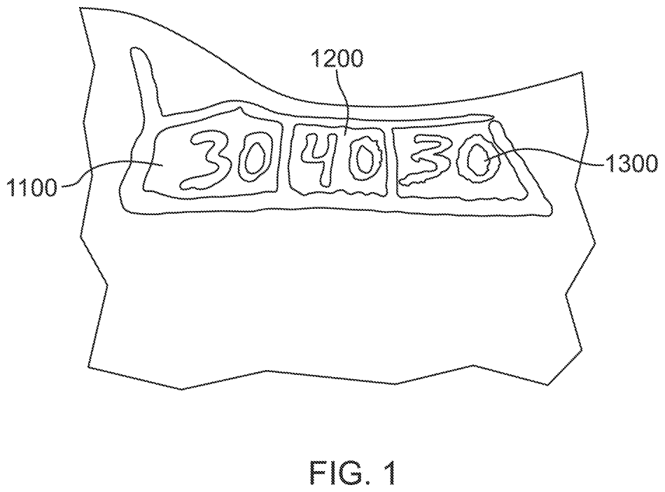

To address the problems posed by a rider's unequal weight distribution across the saddle support area, it helps to conceptualize the back of a horse as being divided into three sections as shown in FIG. 1 of approximately equal surface area. Namely a front section 1100, a middle section 1200, and a rear section 1300 which preferably bear 30%, 40%, and 30% of a rider's weight, respectively.

The front section 1100 has a steeper angle than the middle section 1200 and rear section 1300 and the structure of the saddle positioned over the front section 1100 is generally the strongest since the saddle tree (i.e., the chassis of the saddle) must not widen here to crush or permanently damage a horse's withers or spine during riding. This front section 1100 is also where most damage caused by saddles and saddle bars in the prior art occurs because too much of a rider's weight is distributed onto this area of the horse's back.

The rear section 1300 is also sensitive to pressure, with welfare and performance problems once more occurring if the rear section 1300 receives too much of a rider's weight. The rear section 1300 is also an area where significant damage will occur if a saddle is fitted poorly.

### Positioning the Stirrup Bar and Balancing a Rider's Weight

The goal of a saddle is to distribute the rider's weight over all three sections 1100, 1200, and 1300 as equally as possible to minimize the risk of abnormal pressure points that harm a horse or impede performance. Stirrup bars currently on the market are not attached to the center area of the saddle tree, which is where the rider actually sits and a horse can most easily carry the rider's weight.

Stirrup bars act like a fulcrum, from which the stirrup leather hangs with the stirrups to form a pendulum. This pendulum will regularly carry the rider's weight whenever they assume a position that shifts their weight away from the seat of a saddle to the two points of contact between a rider's feet and a pair of stirrups. The positioning of the stirrup bar and the fulcrum it creates consequently become important in maintaining a rider's balance. If the stirrup bar is too far forward or too far back, a rider will be especially susceptible to inadvertent and possibly dangerous losses of balance and control whenever a rider shifts their weight into the stirrups, like in a rising trot or two point position.

Thus, the point at which a stirrup bar is attached to a saddle tree and the position of the pivot point or fulcrum created by the stirrup bar, stirrup leathers, and stirrups are instrumental in determining what proportion of a rider's weight the front section 1100, middle section 1200, and rear section 1300 will carry and in minimizing the risk of riders losing balance from inadvertent leg swinging.

### Designing a Center-balance Hinged Stirrup Bar

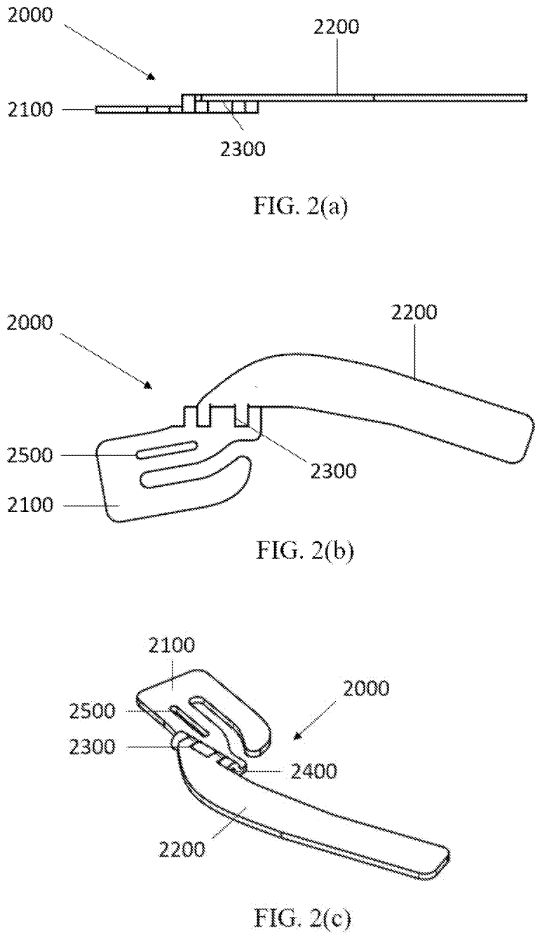

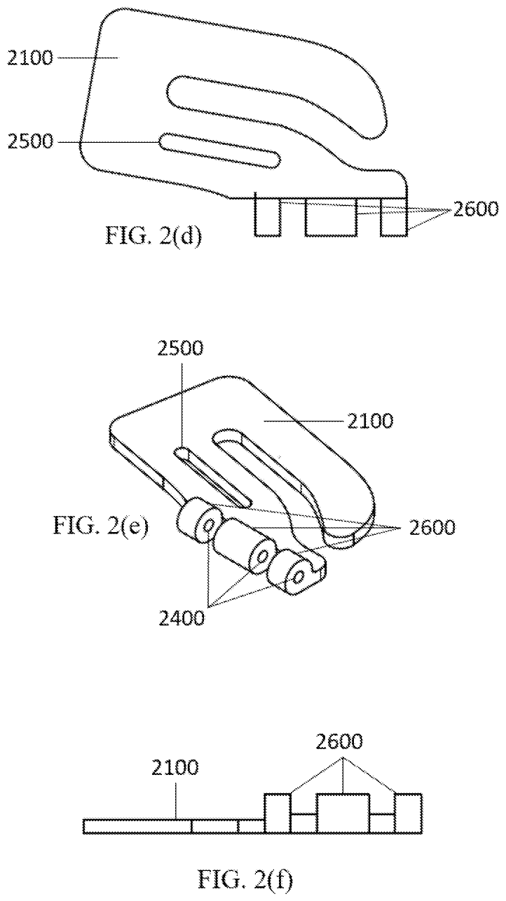

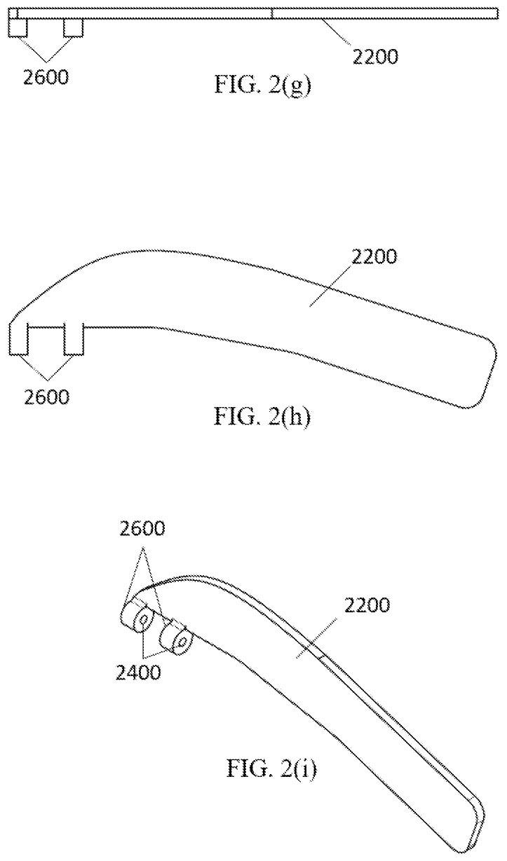

According to an embodiment shown in FIGS. 2(a) to 2(c), there is a center-balance hinged stirrup bar 2000 comprised of a hooked portion 2100 for receiving stirrup leathers and an elongated portion 2200 used to secure the stirrup bar 2000 to a saddle tree, preferably at the saddle tree's center. The hooked portion 2100 is connected to the elongated portion 2200 to form a hinge 2300 using interlocking protruding elements 2600 and a fastener inserted through fastener aperture 2400. The hinge permits free radial movement of the hooked portion 2100 relative to the elongated portion 2200. The hooked portion contains a safety aperture 2500 to secure (via a nylon strap which lays loosely like a belt over the saddle tree) the hook portion 2100 as an extra precaution for the integrity of the interlocking protruding element 2600 and fastener aperture 2400. FIGS. 2(d) to 2(f) show the detached hooked portion 2100 and FIGS. 2(g) to 2(i) show the detached elongated portion 2200.

According to a preferred embodiment, the hooked portion 2100 has a length of 84.818 mm at its longest point and a thickness of 3.454 mm. Furthermore, the elongated portion 2200 has a length of 168.143 mm, a width of 25.400 mm, and a thickness of 3.429 mm. Lastly, the hinge 2300 has a length of 38.100 mm and the interlocking protruding elements 2600 have a diameter of 9.525 mm.

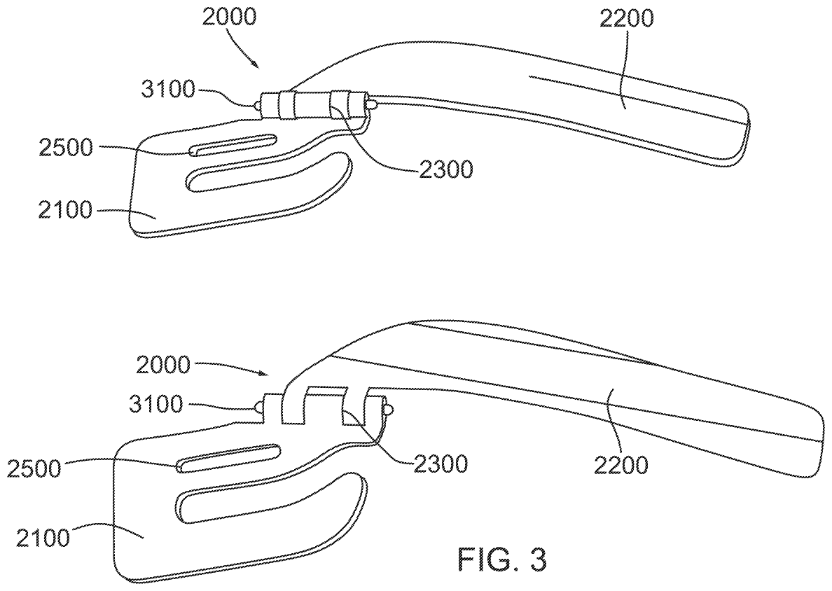

According to a further embodiment shown in FIG. 3, there is a pair of center-balance hinged stirrup bars 2000 where the interlocking elements 2600 on the hooked portion 2100 and elongated portion 2200 form a hinge 2300 by inserting a pin-based fastener 3100 made from hardened steel through the fastener aperture 2400. The pin-based fastener 3100 may have welded ends to help keep it in place. The pair of center-balance hinged stirrup bars 2000 may be constructed such that they have non-superimposable, mirrored designs of each other that each conform to one side of the horse.

The hooked portion or elongated portion of a center-balance hinged stirrup may be interchanged with hooked portions or elongated portions, respectively, of different dimensions and designs to match a horse's body shape, the dimensions of a rider, or to create a desired aesthetic appearance.

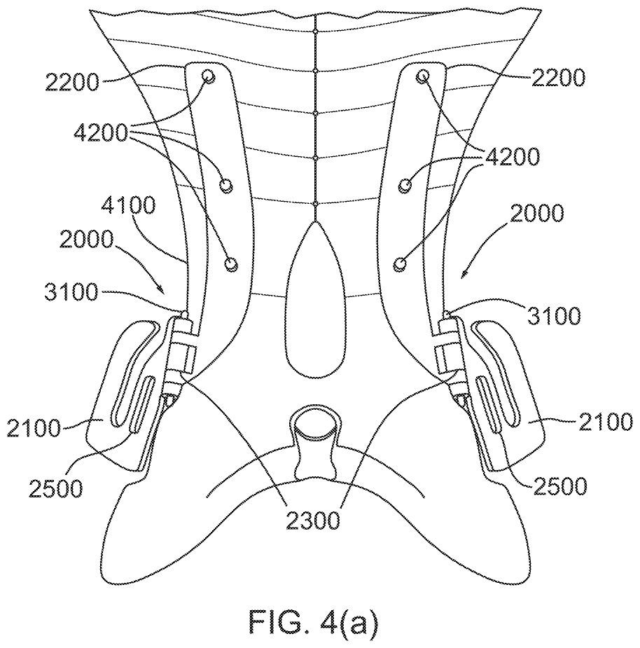

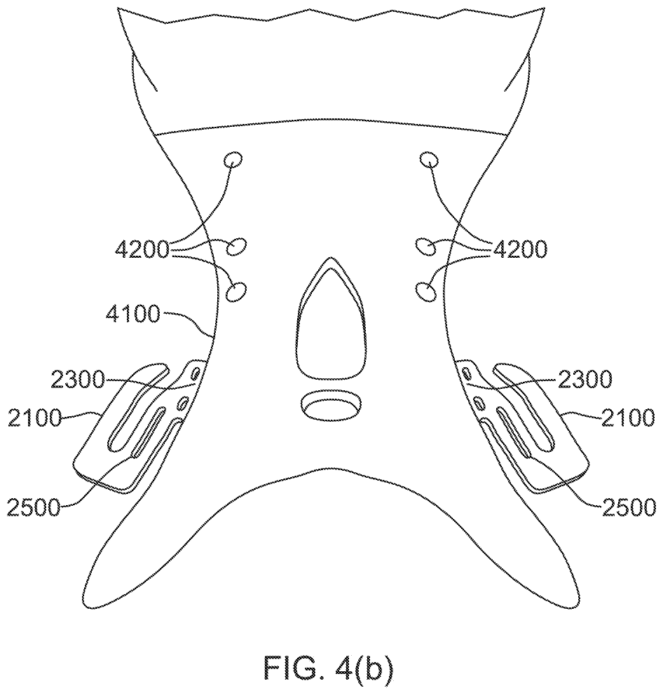

According to an embodiment shown in FIGS. 4(a) and 4(b), a pair of center-balance hinged stirrup bars 2000 are installed on a middle portion of a saddle tree 4100 using at least one installation fastener 4200 on each center-balance hinged stirrup bar 2000. The center-balance hinged stirrup bars 2000 can be installed on the underside of the saddle tree, like as shown in the underside view of a saddle tree 4100 in FIG. 4(a) and the topside view of the saddle tree 4100 in FIG. 4(b). Alternatively, the center-balance hinged stirrup bars 2000 may be installed on the saddle tree's topside. Using three installation fasteners 4200, such as rivets, increases the strength and security of attachment between the elongated portion 2200 of the center-balance hinged stirrup bars 2000 and the saddle tree 4100.

Furthermore, the hinge 2300 permits the hooked portion 2100 to swing freely since it is not secured in a fixed radial position. By swinging freely, the hinge 2300 and hooked portion 2100 allow the stirrup leathers to naturally fall into the correct position for a rider and horse. In other words, a rider will not have to worry about the position of their stirrup bars impeding leg movement, balance, or riding performance.

Free radial movement of the hooked portion 2100 reduces or may negate the need for incorporating spring steel into the saddle tree. The dynamic radial positioning system also reduces the risk of the stirrup bar itself being bent, distorted, or even broken during regular use or during saddle adjustments and fittings. Consequently, there is a lower risk of bent, distorted, or broken stirrup bar parts interfering with the attachment of the stirrup leathers to the stirrup bar and the positioning of the stirrups. Similarly, there is a lower risk that the stirrup bar will be bent, distorted, or broken in such a way that the safety hook or other safety mechanisms of the stirrup bar are not able to operate properly. Thus, riders using saddles fitted with the center-balance hinged stirrup bar 2000 are less likely to be dragged should a rider fall from their horse.

Designing the center-balance stirrup bar 2000 such that the elongated portion 2200 is attached to the middle portion of the saddle tree 4100 and the hooked portion 2100 extends towards the front portion of the saddle tree provides a rider with the ability to effectively balance oneself and maintain control over the horse they are riding without increasing pressure at the front section 1100. The weight of the rider is allocated to the middle section 1200 of a horse's back, which is where a horse can most easily carry the rider's weight, without moving the fulcrum created by the stirrup bar, stirrup leathers, and stirrups from the front of the saddle. This is dissimilar to the stirrup bars in the prior art, which are attached at the front of a saddle tree and shift too much of a rider's weight onto the front section 1100, which can seriously injure the horse.

Furthermore, the pivot mechanism created by the hinge 2300 reduces the likelihood that the center-balance stirrup bar will be inadvertently pushed into the horse's back or the rider's thigh. The dimensions and exact positioning of the center-balance stirrup bar can be adjusted, with the various parts constituting the center-balance stirrup bar 2000 being interchangeable with other parts of different dimensions or designs. This can be done to distribute the weight of a rider more equally across the back of a horse and may be done to accommodate riders or horses of different weights and body shapes. For example, an elongated portion of a center-balance stirrup bar may be swapped out for another, longer elongated portion to move the fulcrum created by the stirrup bar, stirrup leathers, and stirrups farther forward on the saddle, which may improve a rider's comfort or performance.

The hinged design may also reduce unnecessary rocking of the saddle, which is irritating to both horse and rider, and may decrease pressure at the front and back of the saddle by shifting the rider's weight towards the middle section 1200. This decrease in pressure at the front of the saddle permits greater freedom of movement for a horse and less impedance at the shoulder and less pressure on the withers.

While the center-balance stirrup bar 2000 may be used in various saddle types, including English and Western saddles generally, it is especially beneficial when used in jumping saddles or where a rider will commonly assume a two point position (i.e., a position where the rider's legs provide two points of contact in the stirrups, over which the rider's weight is balanced on the horse). Any saddle or riding sport that frequently has riders assume a forward seat or two-point position is more susceptible to abnormal pressure points occurring along a horse's back and the damage to horse welfare and performance resulting therefrom. Consequently, using the center-balance stirrup bar 2000 to shift a rider's weight from the front section 1100 towards the middle section 1200 may potentially change the way rider's ensure ongoing well-being for their horse while maintaining optimal riding performance.

The center-balance stirrup bar 2000 may be used in conjunction with other saddle design choices to further optimize comfort, performance, safety, and horse welfare. For example, the length of a saddle tree and the way foam situated on top of the saddle tree is curved (i.e., the seat curve) help determine whether a rider is forward, center, or rear balanced. These design choices are made based on each rider's specific body requirements, comfort, and to provide the correct seating position for that rider.

Lastly, saddle fitters will be able to do saddle tree adjustments to conform a saddle tree to a horse's specific body conformation with the center-balance stirrup bar by bending the gullet plate, using hydraulic or manual force, without impacting the structure of the saddle tree by compromising rivets. Compromised rivets are a common problem for stirrup bars in the prior art whenever saddle tree adjustments are performed. Thus, use of the center-balance hinged stirrup bar reduces the likelihood of compromising rivets and the costs otherwise resulting from replacement or repairs.

Various embodiments of the invention have been described in detail. Since changes in and or additions to the above-described best mode may be made without departing from the nature, spirit or scope of the invention, the invention is not to be limited to those details but only by the appended claims. Section headings herein are provided as organizational cues. These headings shall not limit or characterize the invention set out in the appended claims.

What is claimed is:

1. A hinged stirrup bar, comprising:
a hooked portion for receiving stirrup leather;
an elongated portion for attachment to a saddle;
wherein the hooked portion and the elongated portion each contain at least one protruding element which interlock to connect the hooked portion and the elongated portion at an adjustable stirrup bar joint;
and wherein the adjustable stirrup bar joint is secured using at least one fastener.

2. The hinged stirrup bar of claim 1, wherein the at least one fastener is a pin fitted through apertures on the at least one protruding element on each of the hooked portion and the elongated portion.

3. The hinged stirrup bar of claim 2, wherein the pin is secured in place via welding once fitted through the apertures.

4. The hinged stirrup bar of claim 1, wherein the adjustable stirrup bar joint permits radial movement of the hooked portion relative to the elongated portion such that positions of the hooked portion and the elongated portion conform to a horse's body shape.

5. The hinged stirrup bar of claim 1, wherein the hooked portion further comprises at least one stirrup leather aperture for receiving stirrup leather.

6. The hinged stirrup bar of claim 1, wherein one or both of the hooked portion and the elongated portion are interchangeable with different hooked portions and elongated portions.

7. The hinged stirrup bar of claim 1, wherein dimensions and designs of the hooked portion and the elongated portion are configured for use in saddle types where a two-point riding position is used.

8. A saddle, comprising,
a saddle tree;
at least one saddle tree covering;
a gullet plate;
stirrup leather;
at least one stirrup;
at least one hinged stirrup bar, further comprising
a hooked portion for receiving the stirrup leather;
an elongated portion;
wherein the hooked portion and the elongated portion each contain at least one protruding element which interlock to connect the hooked portion and the elongated portion at an adjustable stirrup bar joint;
and wherein the adjustable stirrup bar joint is secured using at least one fastener;
wherein the saddle is comprised of a front portion, a middle portion, and a rear portion;
wherein the saddle tree is comprised of a front tree portion, a middle tree portion, and a rear tree portion;
wherein the hinged stirrup bar is installed at the middle portion of the saddle by attaching it to the middle tree portion of the saddle tree using at least one installation fastener;
and wherein the hinged stirrup bar creates a pivot point for the stirrup leather at the front portion of the saddle.

9. The saddle of claim 8, wherein the hinged stirrup bar acts to reduce one or more of: rocking of the saddle, impedance to a horse's movement, pressure at the front portion of the saddle and pressure at the rear portion of the saddle.

10. The saddle of claim 8, wherein the hinged stirrup bar operates to distribute a rider's weight across the front portion, the middle portion, and the rear portion of the saddle.

11. The saddle of claim 8, wherein the at least one hinged stirrup bar is a pair of hinged stirrup bars with non-superimposable, mirrored designs.

12. The saddle of claim 8, wherein one or both of the hooked portion and the elongated portion are interchangeable with different hooked portions and elongated portions.

13. The saddle of claim 8, wherein the at least one installation fastener is a set of three rivets securing the elongated portion to the middle tree portion.

14. The saddle of claim 8, wherein the front portion, the middle portion, and the rear portion of the saddle are designed such that a weight applied to the middle portion is distributed more evenly across the front portion, the middle portion, and the rear portion of the saddle.

15. The saddle of claim 8, wherein dimensions and designs of the hooked portion and the elongated portion are configured for use in a saddle where a two-point riding position is used.

16. A method of balancing a rider's weight on a horse, comprising,
installing a hinged stirrup bar on a middle portion of a saddle; the hinged stirrup bar comprising:
a hooked portion for receiving the stirrup leather;
an elongated portion;
wherein the hooked portion and the elongated portion each contain at least one protruding element which interlock to connect the hooked portion and the elongated portion at an adjustable stirrup bar joint;
and wherein the adjustable stirrup bar joint is secured using at least one fastener;
placing the saddle on a saddle support area on the horse's back;
positioning the saddle over the saddle support area such that a front portion, the middle portion, and a rear portion of the saddle align with a front support portion, a middle support portion, and a rear support portion of the saddle support area;
securing the saddle to the horse using at least one saddle fastener; and
distributing the rider's weight approximately evenly across the saddle support area using a pivot point for stirrup leather created at the front portion of the saddle by the hinged stirrup bar on the middle portion of the saddle.

17. The method of claim 16, wherein the approximately even distribution of the rider's weight reduces one or more of: rocking of the saddle, impedance to the horse's movement, pressure at the front portion of the saddle and pressure at the rear portion of the saddle.

18. The method of claim 16, wherein the saddle support area is approximately 4 inches wide by 16 inches long on each side of the horse's back.

19. The method of claim 16, further comprising adjusting a saddle tree of the saddle to conform to a horse's body shape by bending a gullet plate that can be installed on the saddle tree.

20. The method of claim 19, wherein the gullet plate is bent without impacting the structure of the saddle tree and without bending, distorting, or breaking the hinged stirrup bar.
